(19) United States
(12) Patent Application Publication
(10) Pub. No.: US 2020/0240095 A1
(43) Pub. Date: Jul. 30, 2020

(54) INTEGRATED ARROW BOARD AND LIGHT TOWER

(71) Applicants: Vincenzo Rizzo, Hazlet, NJ (US); Valentino Rizzo, Hazlet, NJ (US)

(72) Inventors: Vincenzo Rizzo, Hazlet, NJ (US); Valentino Rizzo, Hazlet, NJ (US)

(21) Appl. No.: 16/747,753

(22) Filed: Jan. 21, 2020

Related U.S. Application Data
(60) Provisional application No. 62/798,050, filed on Jan. 29, 2019.
(60) Provisional application No. 62/807,877, filed on Feb. 20, 2019.

(51) Int. Cl. E01F 9/615; E01F 9/692; E01F 9/608; G08G 1/0955; G08G 1/054; E01F 9/646

(52) U.S. Cl. CPC E01F 9/615; E01F 9/692; E01F 9/646; G08G 1/0955; G08G 1/054; E01F 9/608

(57) ABSTRACT

A system includes a directional sign having a plurality of lights capable of indicating an intended traffic direction, a telescoping central mast coupled to the sign, a base coupled to the central mast, the base having wheels, and at least one light in communication with at least one power source, the at least one light being disposed on the telescoping central mast.

### CROSS-REFERENCE TO RELATED APPLICATIONS

The present disclosure claims priority to U.S. Provisional patent application Ser. No. 62/798,050, filed Jan. 29, 2019 and U.S. Provisional patent application Ser. No. 62/807,877, filed Feb. 20, 2019, the contents of both of which are hereby incorporated by reference in their entirety.

### FIELD OF THE DISCLOSURE

The present disclosure relates to devices and methods for increasing safety at construction sites. More particularly the present disclosure relates to signs and lighting used during road repair and other construction projects.

### BACKGROUND OF THE DISCLOSURE

Warning signs and traffic control devices are typically set up at road construction sites. Such control devices may include orange cones or pylons which gradually shut down a lane and funnel the approaching traffic into one or more other lanes. While these types of devices serve a purpose, they may not be suitable for higher speed traffic. In such cases, when there is a scheduled construction site on a state or federal highway, there is likely ample time to bring to that site suitable warning or alert devices, such as “arrow boards”. Typically, these arrow boards are large, bulky devices which have to be trucked or towed to the construction site.

Additionally, light towers are often used to illuminate the work site and the traffic control devices. Certain states or jurisdictions mandate that a light tower be present in areas that require arrow boards. Transporting, setting up and removing both an arrow board and a light tower is inefficient.

Moreover, construction sites tend to be unsafe due to velocity of vehicles, for example, on a highway. While signs are typically laid out to warn drivers of the construction, there is no automatic method of enforcing the speed at the construction zones.

### SUMMARY OF THE DISCLOSURE

In some examples, an integrated system includes a directional sign having a plurality of lights capable of indicating an intended traffic direction, a telescoping central mast coupled to the sign, a base coupled to the central mast, the base having wheels, at least one light in communication with at least one power source, the at least one light being disposed on the telescoping central mast, and a camera integrated with the directional sign and capable of taking a photograph of oncoming vehicles.

### BRIEF DESCRIPTION OF THE DISCLOSURE

Various embodiments of the presently disclosed systems are disclosed herein with reference to the drawings, wherein:

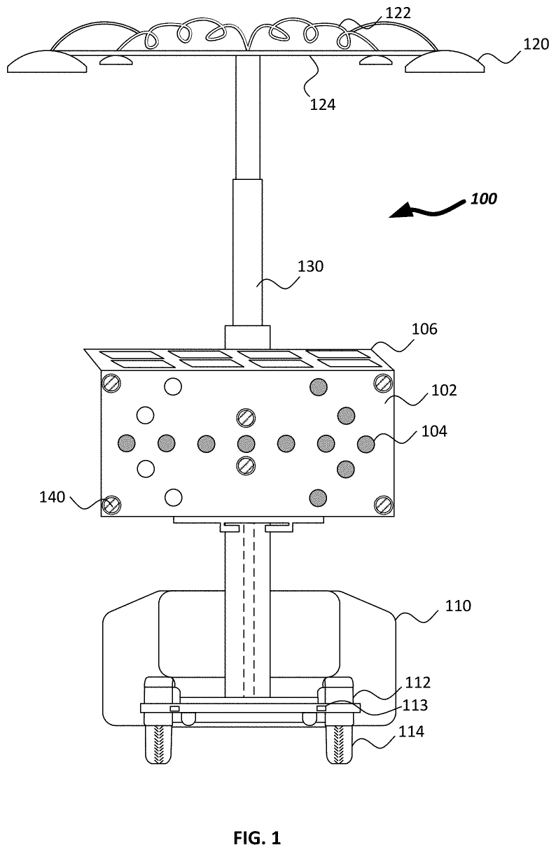

FIG. 1 is a schematic front view of the integrated traffic control device according to one embodiment of the present disclosure; and

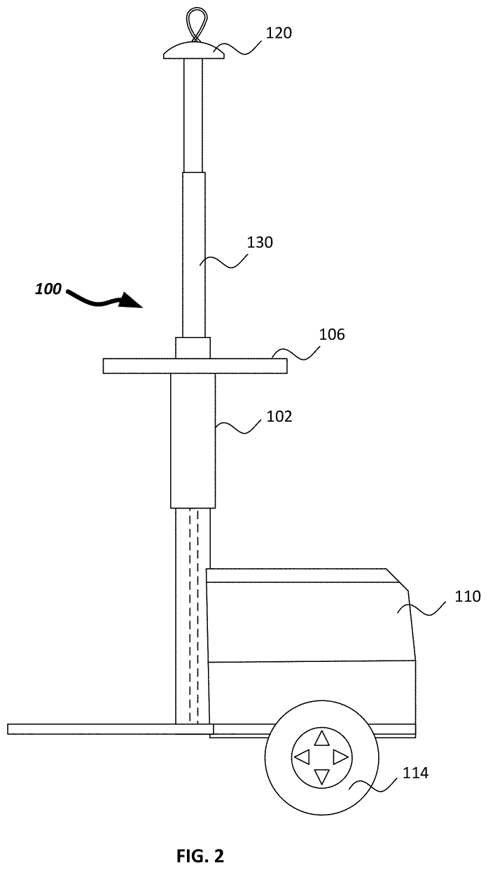

FIG. 2 is a schematic side view of the integrated traffic control device of FIG. 1; and

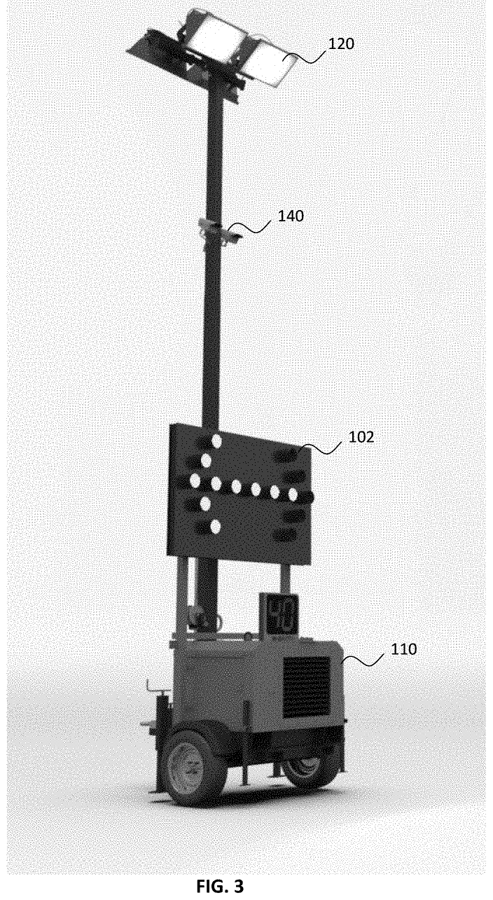

FIG. 3 is a schematic side view of another embodiment of an integrated traffic control device.

Various embodiments of the present invention will now be described with reference to the appended drawings. It is to be appreciated that these drawings depict only some embodiments of the invention and are therefore not to be considered limiting of its scope.

### DETAILED DESCRIPTION

Despite the various improvements that have been made to construction equipment, conventional devices and methods suffer from certain shortcomings such as those discussed above.

There therefore is a need for further improvements to the devices and methods used to control traffic flow and illuminate work sites, and to increase safety of the work site. Among other advantages, the present disclosure may address one or more of these needs.

FIG. 1 is a schematic front view of a traffic control device 100 having an integrated arrow board and light tower. As shown, device 100 includes an arrow board 102 having a plurality of lights or bulbs 104, that are able to form arrows to show oncoming traffic where to go in case of a lane or shoulder closure. As used herein, the word “bulb” may represent a single light or a cluster of lights (e.g., LED lights) grouped together to form a shape, such as each of the circles in the arrow board shown. Lit bulbs 104 are shown in gray, the bulbs indicating a right traffic shift. Optionally, arrow board 102 may include a solar panel 106 that faces the sun to provide power for lights 104. Arrow board 102 may alternatively, or additionally, be powered by a generator as described below. In at least some examples, each bulb 104 may include LED lights, the LED lights collectively forming a single bulb. For example, 30 or more LED lights may form a single circular bulb, and the arrow board may include 15 bulbs.

Arrow board 106 may be mounted on a telescoping central mast 130 as shown. The bottom of central mast 130 may be coupled to a base 112 having reflectors 113 and wheels 114. A generator 110 may also be formed as part of base 112 and act as a power source, the generator being capable of providing sufficient power for the light tower and/or the arrow board. Light tower may include a plurality of worksite lights 120. As shown, light tower includes four worksite lights, although any number of lights may be used. Worksite lights 120 may be coupled to electrical lines 122, and supported by horizontal or X-shaped support 124. Electrical lines 122, in turn, may extend through central mast 130 and be coupled to generator 110.

Central mast 130 may be formed of three or more telescoping portions as shown and the height of the central mast 130 may be adjusted as necessary. In at least some examples, central mast 130 may be adjustable to have a height of between 8 feet and 20 feet. Thus, central mast may be disposed in the compact condition during transport and storage, and in the extended condition during use.

In some embodiments, the arrow board 102 may include an integrated speed camera. Such speed camera may be effective in insuring that the vehicles slow down near a work site, increasing the safety of workers. Speed cameras detect the speed of vehicles by using detectors. If the speed of the vehicle exceeds the legal limit in the construction site, a digital photograph may be taken of the offending vehicle. If an offence is detected, a digital image of the vehicle may be recorded, which may include information such as the colour, type, make and license plate of the vehicle. These images may be stored in a database that also includes any of the following information; date of the offence, time of the offence, location details of the camera that took the photograph, direction of travel of the offending vehicle, speed of the offending vehicle, speed limit on the road where the camera is positioned. In some examples, the speed camera includes any of the following components: a camera 140 capable of taking multiple photos of a vehicle, a processor (not shown) configured to calculate the displacement of the vehicle with respect to the two photos over a period of time, a speed detector that includes radar or laser technology. The speed camera 140 may be integrated with the arrow board so that it is placed at any one of the positions shown in FIG. 1. This includes any one of the corners of arrow board 102 or at a location above or below the LED lights. In at least some examples, the arrow board 102 also serves as a housing and the camera is disposed and protected by the arrow board, only a front portion of the camera being visible through the arrow board to take photograph as necessary. In at least some embodiments, the camera is mounted within the arrow board and faces oncoming traffic coming from a first direction to which the LED lights are visible. Alternatively, the camera may be mounted on the back of the arrow board and configured to face traffic in the second direction opposite the oncoming traffic of the first direction. Cameras may also be mounted on both sides of the arrowboard.

In FIG. 3, another embodiment is shown where an integrated device includes an arrow board 102, worksite lights 120, a central mast having multiples speed cameras 140 and a generator 110.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

It will be appreciated that the various dependent claims and the features set forth therein can be combined in different ways than presented in the initial claims. It, will also be appreciated that the features described in connection with individual embodiments may be shared with others of the described embodiments.

What is claimed is:

1. A device comprising:
a directional sign having a plurality of lights capable of indicating an intended traffic direction;
a telescoping central mast coupled to the sign;
a base coupled to the central mast, the base having wheels;
at least one light in communication with at least one power source, the at least one light being disposed on the telescoping central mast; and
a camera integrated with the directional sign and capable of taking a photograph of a vehicle.

2. The device of claim 1, wherein the plurality of lights are configured and arranged to form arrows in at least two directions, the arrows being formed by turning on certain ones of the lights, and turning off other ones of the lights.

3. The device of claim 2, wherein the plurality of lights include multiple bulbs.

4. The device of claim 3, wherein each bulb includes a single light.

5. The device of claim 3, wherein each bulb includes a cluster of lights.

6. The device of claim 3, wherein each bulb includes a number of LED lights.

7. The device of claim 1, wherein the camera is capable of taking multiple photographs of the vehicle.

8. The device of claim 1, further comprising a processor capable of calculating a displacement of the vehicle from two photographs taken by the camera to calculate a speed.

9. The device of claim 1, wherein the camera calculates a speed of the vehicle using a radar.

10. The device of claim 1, wherein the camera calculates a speed of the vehicle using a laser.

11. The device of claim 1, wherein the camera is at least partially disposed inside the directional sign.

12. The device of claim 1, wherein the camera is partially exposed.

13. The device of claim 1, wherein the camera faces a same side as the plurality of lights.

14. The device of claim 1, wherein the camera faces an opposite side as the plurality of lights.

15. A device comprising:
a directional sign having a plurality of lights capable of indicating an intended traffic direction, the plurality of lights being configured and arranged to form arrows in at least two directions;
a telescoping central mast coupled to the sign;
a base coupled to the central mast, the base having wheels;
at least one light in communication with at least one power source, the at least one light being disposed on the telescoping central mast; and
a camera at least partially disposed inside the directional sign and capable of taking a photograph of a vehicle.

16. The device of claim 15, further comprising a processor capable of calculating a displacement of the vehicle from two photographs taken by the camera to calculate a speed.

17. The device of claim 15, wherein the camera calculates a speed of the vehicle using a radar.

18. The device of claim 15, wherein the camera calculates a speed of the vehicle using a laser.

19. The device of claim 15, wherein the camera is partially exposed.

20. The device of claim 15, wherein the camera faces a same side as the plurality of lights.
